(19) United States
(12) Patent Application Publication
(10) Pub. No.: US 2007/0209537 A1
(43) Pub. Date: Sep. 13, 2007

(54) Ink fountain roller of a web-fed press

(75) Inventors: Ralph Klarmann, Augsburg (DE); Peter Schulmeister, Pfaffenhofen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/701,825

(22) Filed: Feb. 2, 2007

(30) Foreign Application Priority Data
Feb. 4, 2006 (DE) 10 2006 005 120.3

(51) Int. Cl. B41F 31/14

(52) U.S. Cl. 101/348

(57) ABSTRACT

An ink fountain roller has a metal core and a plasma coating that is applied by plasma immersion ion implantation. The coating has a total surface energy of 35 mN/m or less, and a polar component of less than 7 mN/m. The coating is applied in a vacuum chamber by generating a metal plasma over the core, wherein the metal has a valence of +4 or +6 and is preferably at least one of titanium, molybdenum, and zirconium. Positive ions in the plasma are accelerated toward the core by applying negative high voltage pulses (5-15 kV) with very short pulse rise times (<1 μsec) to the plasma, thereby causing positive ions in the plasma to be implanted in the core. An intermediate layer of metal or ceramic may be applied to the core prior to applying the plasma coating.

### BACKGROUND OF THE INVENTION

1. Field of the Invention

The invention concerns an ink fountain roller of a wed-fed press with at least one inking unit from which the ink fountain roller takes up ink, wherein the ink fountain roller has a metal core.

2. Description of the Related Art

Ink fountain rollers of web-fed presses receive the printing ink from a film inking unit and transfer it, usually by other ink transfer rollers, to the printing plate cylinder, which transfers the ink to a blanket cylinder and, finally, to the subject.

It is essential to the printing result that the ink acceptance of the ink fountain roller is homogeneous, that the ink film on the ink fountain roller does not separate, and that the ink fountain roller does not glaze or run dry.

In this regard, glazing or separation of the ink film on the ink fountain roller depends on the composition of the printing ink, the concentration of the fountain solution used in printing, and contaminants possibly adhering to the surface of the ink fountain roller.

Ink fountain rollers with a ceramic surface are already known from the prior art. They usually consist of a mixture of chromic oxide (Cr₂O₃) and titanium dioxide (TiO₂). However, they fail to achieve satisfactory results with respect to glazing properties.

An improvement of the glazing properties was achieved by ink fountain rollers with a metallic spray coating, which was applied to the ink fountain roller by high-velocity flame spraying. In this regard, the metallic spray coating preferably consists of a metal alloy, for example, an alloy of nickel (Ni), chromium (Cr), iron (Fe), boron (B), and silicon (Si). Although this metallic surface can improve glazing compared to ceramic surfaces, it cannot completely prevent glazing. Until now, additional antiadhesive pastes have been used to prevent glazing of ink fountain rollers, but they have only a temporary effect.

Besides glazing of the ink fountain roller, the inking unit can also be affected by the problem of contaminants. These contaminants, for example, paper dust, get into the ink of the inking unit, where they are picked up by the ink fountain roller. Contaminants adhering to the surface of the ink fountain roller in turn promote downward migration of ink and thus glazing.

### SUMMARY OF THE INVENTION

Proceeding on the basis of this prior art, the present invention is based on the problem of creating an ink fountain roller of a web-fed press that has a surface in which the phenomenon of glazing or separation of the ink film is still further reduced or completely prevented, and at the same time the surface is to be formed in such a way that contaminants adhere less strongly to it or do not adhere to it at all.

The inventors realized that above all the surface energy and in this regard primarily the polar component of the surface of the ink fountain roller is decisive for its oleophilic or hydrophobic properties. The lower the surface energy is, the more “ink-friendly” and “water-unfriendly” the surface is. This also explains the fact that the metallic high-velocity flame spray coating on the surface of the ink fountain roller, which has a higher density and a lower surface energy than a ceramic surface of an ink fountain roller, also shows better ink acceptance and thus less pronounced glazing properties.

The inventors also realized that the morphology or the topography of the surface affects the glazing properties of the surface of the ink fountain roller. For example, contaminants, especially calcium carbonate and kaolin, can accumulate in the pores and microcracks in the surface of the ink fountain roller. The hydrophilic properties of these contaminants allow them to act as nucleation sites for the unwanted spreading out of fountain solution on the surface of the ink fountain roller, which causes downward migration of the ink and eventually glazing of the ink fountain roller.

DE 195 16 032 C2 discloses a method for finishing the surface of an ink transfer roller, in which ion implantation is used to apply a metallic coating to the surface of the ink transfer roller, which is provided with grooves or recesses. The ink transfer roller rotates at a high speed of rotation of the printing press of up to 60,000 revolutions per minute and is thus subject to strong abrasion and wear. The metallic coating applied by ion implantation is intended to increase the service life of the ink transfer roller by minimizing abrasion. At the same time, it is meant to improve the properties of the ink transfer roller with respect to corrosion.

The ink fountain roller, on the other hand, rotates at a speed of rotation about 1/60 as fast. This low speed of rotation is necessary to ensure homogeneous acceptance of the ink from the ink fountain and to prevent the ink from being swirled up. Due to the much lower speed of rotation, the ink fountain roller is subject to less wear than the ink transfer roller. In the past, it has not seemed worthwhile to use a plasma coating on the surface of an ink fountain roller, especially since the coating process can be relatively expensive.

On the basis of these realizations, the inventors propose that an ink fountain roller of a web-fed press be improved by providing the surface of the roller with a coating applied by plasma immersion ion implantation.

The advantages of conventional ion implantation can be transferred to large-surface, complex geometries by means of plasma immersion ion implantation, which is also referred to simply as ion implantation or vacuum plasma technology. In this regard, plasma immersion ion implantation is distinguished from thermal spray plasma coating. In plasma immersion ion implantation, the workpiece to be treated is coated in a vacuum chamber by a plasma generated by a suitable plasma source. By applying negative high-voltage pulses with a frequency of 500-2000 Hz and very short pulse rise times on the order of less than one microsecond, the more highly mobile electrons of the plasma are repelled, and the positive ions that are left behind are accelerated towards the workpiece or implanted. The acceleration voltages are in the range of 5-15 kV; this is below the acceleration voltages of conventional ion implantation, which are on the order of 30 kilovolts. Temperatures are in a range of 50-200° C., as determined by structure size, without active controls. The method finds use in the aerospace industry and in the field of medical implants due to the improvement in the mechanical strength of metal components. Another advantage of plasma immersion ion implantation is that it can be used not only for coating but also for structural modification.

The invention makes it possible to reduce microcracks with diameters in the submicron range in the surface of the ink fountain roller, so that the surface becomes smoother, and fewer contaminants can adhere to it. In addition, this plasma coating offers the specific advantage of favorable values with respect to the polar component and the disperse component of the surface energy.

Examples of metals that are suitable for plasma coating are titanium, molybdenum, zirconium, and/or other metals with a valence of +4 or +6.

The plasma coating can also be formed as a multilayer coating and preferably comprises at least two layers.

The composition of the plasma coating should be selected in such a way that the lowest possible total surface energy of a maximum of about 35 mN/m is obtained. The total surface energy σₜₒₜₐₗ is the sum of the polar surface energy component σₚₒₗₐᵣ and the dispersive surface energy component σ_{dispersive}.
σₜₒₜₐₗ=σₚₒₗₐᵣ+σ_{dispersive}

In this connection, a suitable method for determining the surface energy is the sessile drop method, in which at least three test liquids are applied to the surface.

In addition, the composition of the plasma coating should be selected in such a way that a polar component of the surface energy of a maximum of 7 mN/m is obtained. With a polar component of the surface energy of a maximum of 7 mN/m and a total surface energy of 35 mN/m, a dispersive component of the surface energy of 28 mN/m is obtained.

The specific fractions of polar and dispersive components of the surface energy are thus largely adapted to the values of typical offset printing inks. In accordance with a supplementary criterion, the composition of the plasma coating should be selected in such a way that water has a wetting angle of a minimum of 70° on the surface.

A thermal spray coating that preferably consists of metal and/or ceramic can be applied between the metal core and the plasma coating. In this regard, the intermediate layer is preferably applied to the core by high-velocity flame spraying. The metallic intermediate layer should contain at least nickel, chromium, iron, boron, and silicon. The effect and the adhesion of the plasma coating vary according to the composition of the metal.

The total layer thickness of the metallic plasma coating can be 100 nm to 3 μm.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic representation of a scanning electron micrograph of the surface of an ink fountain roller. The surface consists of a ceramic coating. Magnification 500×;

FIG. 2 is a schematic representation of a scanning electron micrograph of the surface of an ink fountain roller. The surface consists of a metallic spray coating. Magnification 500×;

FIG. 3 is a section of the surface from FIG. 2;

FIG. 3A shows EDX analysis spectra for the surface of FIG. 3;

FIG. 4 is a diagram with Kaelble circles of different ink fountain roller surfaces;

FIG. 5 shows a two-layer structure of an ink fountain roller; and

FIG. 6 shows a three-layer structure of an ink fountain roller.

### DETAILED DESCRIPTION OF THE PRESENTLY PREFERRED EMBODIMENTS

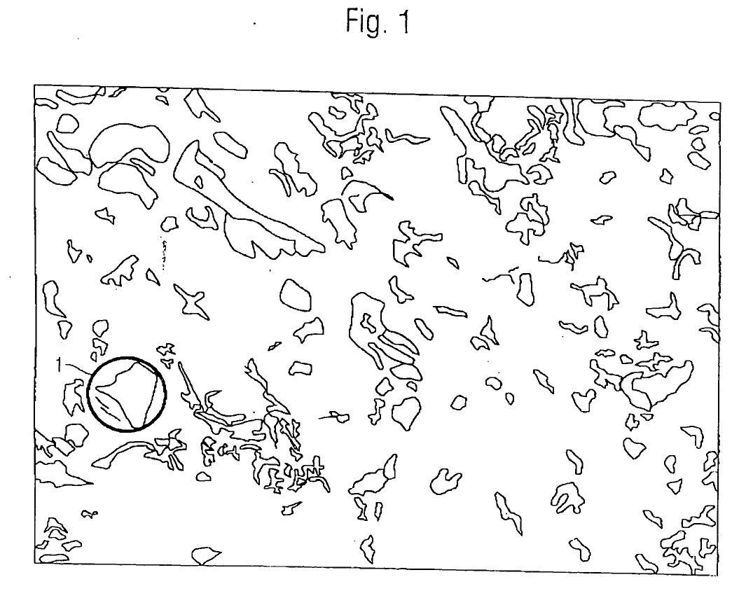

FIG. 1 is a schematic representation of a scanning electron micrograph of a ceramic coating of the surface of an ink fountain roller at a magnification of 500×. Topographic height differences were outlined in this schematic representation. The ceramic coating consists of a mixture of chromic oxide (Cr₂O₃) and titanium dioxide (TiO₂). The section of the ceramic surface shown here corresponds approximately to a width of 250 μm and a height of 180 μm (1 μm=10⁻⁶ μm). Depressions 1 (circumscribed area) are clearly visible on this surface, and some of them have diameters of about 20 μm. The inventors realized that undesired contaminants can accumulate in these depressions. The ink fountain roller of the invention is realized with a smoother surface.

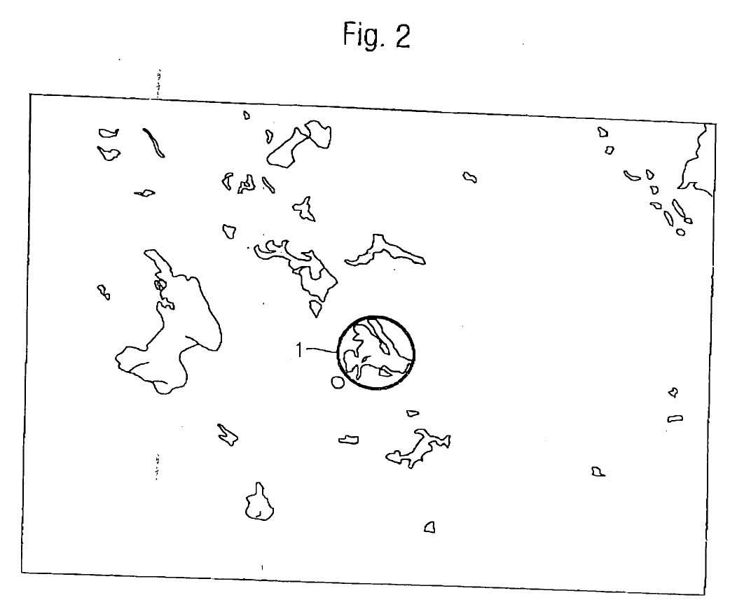

FIG. 2 is a schematic representation of a scanning electron micrograph of a metallic spray coating of the surface of an ink fountain roller at a magnification of 500×. The dimensions of the section shown here are the same as in FIG. 1. It is readily apparent that the number of depressions 1 is much smaller with a metallic ink fountain roller surface than with a ceramic coating. As described earlier, contaminants, especially calcium carbonate and kaolin, can accumulate inside these depressions in the surface of the ink fountain roller, and the hydrophilic properties of these contaminants allow them to act as nucleation sites for the unwanted spreading out of fountain solution on the surface of the ink fountain roller, which causes downward migration of the ink and eventually glazing of the ink fountain roller.

The metallic surface of the ink fountain roller with its lower surface energy and reduced number of depressions greatly reduces the probability of contamination of the surface of the ink fountain roller.

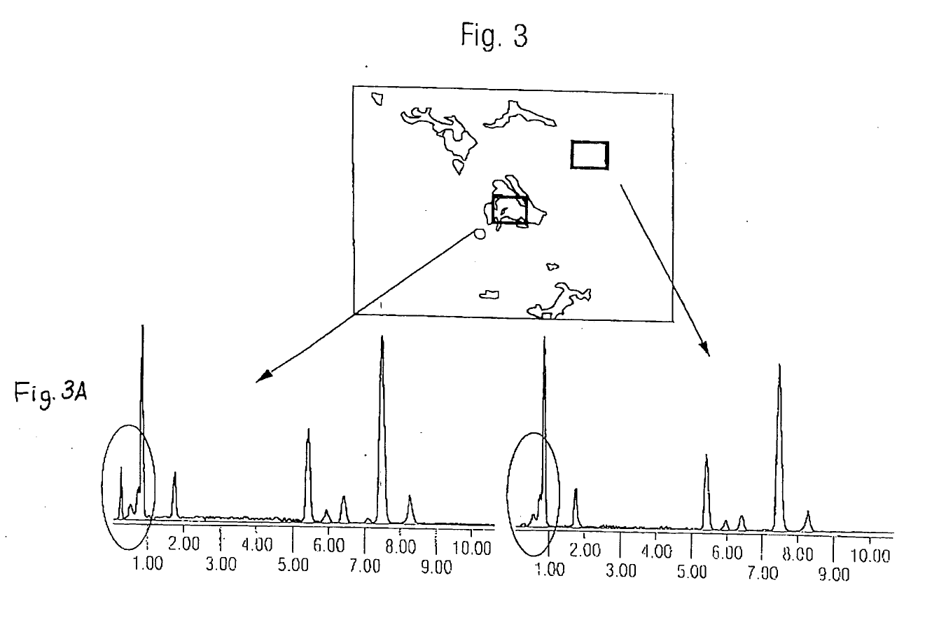

FIG. 3 shows a section of the surface from FIG. 2 with EDX analysis spectra shown below it in FIG. 3A. The EDX analysis, in which an energy dispersive x-ray fluorescence analysis is performed, is used to determine the occurrence of certain substances or their concentrations. The elliptically surrounded area of the left EDX spectrum shows not only the metallic components of the surface of the ink fountain roller but also a clearly elevated concentration of carbon (first peak) in the vicinity of the depressions. By contrast, the “carbon peak” of the smooth roller surface in the elliptically surrounded area of the right EDX spectrum is smaller in height. This indicates that organic impurities preferentially accumulate in the depressions.

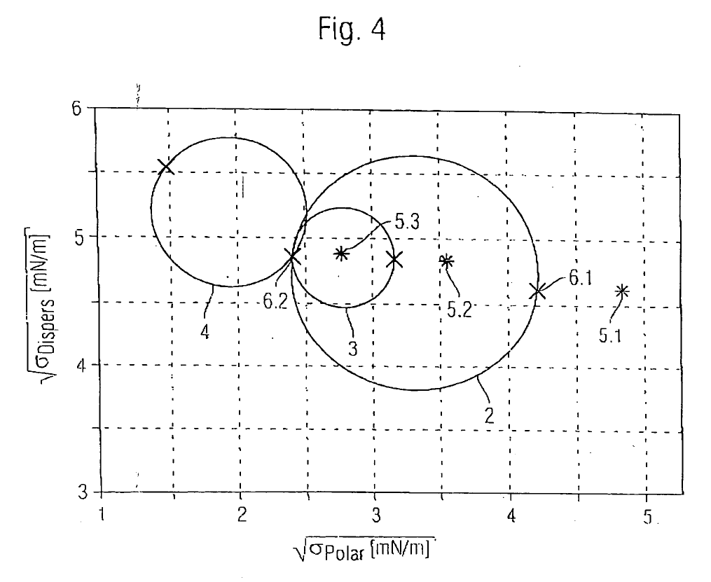

FIG. 4 shows a diagram with Kaelble circles of different ink fountain roller surfaces. With respect to Kaelble theory, the reader is referred to the publication “Surface Analysis of Lithography” from Polymer Science Technology (1975), pp. 735-761, by D. H. Kaelble, P. I. Dynes, and D. Pav, the contents of which are incorporated in this document. In this diagram, the square root of the polar component of the surface energy is plotted on the x-axis, and the square root of the dispersive component of the surface energy is plotted on the y-axis, in \sqrt{mN/m} in each case. The interaction of a surface and the ink on the ink fountain roller is plotted as a circle in the diagram, wherein the two pairs of values of surfaces 6.1 and ink 6.2 are points on the diameter of the circle, so that the diameter is completely characterized. Using the circles, it is now possible to answer the question of whether a liquid can displace the ink on the surface or not. In this regard, three cases are distinguished:

(a) The surface tension of the liquid lies outside the Kaelble circle. This means that the liquid cannot displace the ink from the surface of the ink fountain roller.

(b) The surface tension of the liquid lies inside the Kaelble circle. This means that the liquid can displace the ink from the surface of the ink fountain roller.

(c) The surface tension of the liquid lies on the Kaelble circle. This limiting case means that small variations in a characteristic of the liquid, for example, its temperature, degree of contamination, etc., can affect whether the ink can or cannot be displaced from the surface of the ink fountain roller.

The diagram in FIG. 4 shows three Kaelble circles of three different surface materials of ink fountain rollers and three different fountain solutions 5.1 to 5.3. Circle 2 is the Kaelble circle of a ceramic coating that consists of chromic oxide (Cr₂O₃) and titanium dioxide (TiO₂). Circle 3 is the Kaelble circle of a metallic coating that consists of nickel (Ni), chromium (Cr), iron (Fe), boron (B), and silicon (Si) and was applied by high-velocity flame spraying. Circle 4 is the Kaelble circle of a metallic Coating, which was then additionally plasma-coated. The first fountain solution 5.1 lies outside all of the Kaelble circles 2 to 4 and cannot displace the ink from the surface of the ink fountain roller. The second fountain solution 5.2 lies outside Kaelble circles 3 and 4 with the metallic coating and the metallic plasma coating. On these two surfaces, the ink cannot be displaced from the surface of the ink fountain roller by the second fountain solution 5.2. However, the second fountain solution 5.2 does displace the ink on the ceramic surface, because it lies inside Kaelble circle 2. The diagram in FIG. 4 reveals that the metallic plasma coating is favorable with respect to all three fountain solutions 5.1 to 5.3. None of these fountain solutions 5.1 to 5.3 is able to displace the ink from the metallic plasma coating.

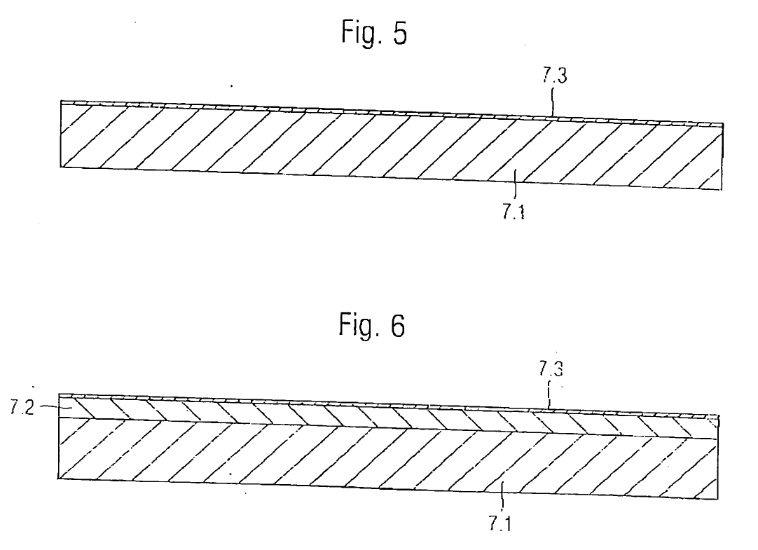

FIG. 5 shows a possible two-layer structure of an ink fountain roller. In this embodiment, the plasma coating 7.3 is applied directly to the core 7.1 of the ink fountain roller.

FIG. 6 shows a possible three-layer structure of an ink fountain roller. In contrast to the two-layer structure of FIG. 5, a metallic intermediate layer 7.2 consisting of nickel (Ni), chromium (Cr), iron (Fe), boron (B), and silicon (Si) is applied between the plasma coating 7.3 and the core 7.1 of the ink fountain roller. Alternatively, the intermediate layer could consist of ceramic material instead of metal.

The problem of glazing is generally further reduced or eliminated by the ink fountain roller of the invention. Furthermore, the ink fountain roller of the invention makes it possible to use far more fountain solutions which do not displace the ink from the surface of the ink fountain roller.

It is understood that the features described above and the features specified in the claims can be used not only in the specified combinations but also individually or in other combinations without exceeding the bounds of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An ink fountain roller of a web-fed rotary printing press with at least one inking unit from which the ink fountain roller takes up ink, said ink fountain roller comprising:
a metal core; and
a plasma coating that is applied on said core by plasma immersion ion implantation.

2. The ink fountain roller of claim 1 wherein the plasma coating comprises at least one metal having a valence of +4 or +6.

3. The ink fountain roller of claim 2 wherein said metal in said plasma coating comprises at least one of titanium, molybdenum, and zirconium.

4. The ink fountain roller of claim 1 wherein said-plasma coating comprises at least two layers.

5. The ink fountain roller of claim 1 wherein the plasma coating has a total surface energy of 35 mN/m or less.

6. The ink fountain roller of claim 5 wherein the surface energy comprises a polar component with a maximum value of 7 mN/m or less.

7. The ink fountain roller of claim 5 wherein the surface energy comprises a dispersive component with a maximum value of 28 mN/m or less.

8. The ink fountain roller of claim 1 wherein the plasma coating has a composition which is selected so that water on said coating has a wetting angle of at least 70 degrees.

9. The ink fountain roller of claim 1 further comprising a metallic intermediate layer between said core and said plasma coating, said metallic intermediate layer being applied by high velocity flame spraying.

10. The ink fountain roller of claim 9 wherein the metallic intermediate layer comprises at least nickel, chromium, iron, boron, and silicon.

11. The ink fountain roller of claim 1 wherein the total thickness of the plasma layer is 100 nm to 3 μm.

12. A method of manufacturing an ink fountain roller having a plasma coating, said method comprising:
placing a metal core in a vacuum chamber;
generating a plasma over said metal core, said plasma comprising at least one metal having a valence of +4 or +6; and
applying negative high voltage pulses to said metal core, said pulses having a voltage in the range of 5-15 kV,
whereby positive metal ions in said plasma are accelerated toward said metal core and implanted therein, thereby providing the core with a plasma coating.

13. The method of claim 12 wherein the voltage pulses are applied with a frequency of 500-2000 Hz.

14. The method of claim 12 wherein the voltage pulses have a pulse rise time of less than one microsecond.

15. The method of claim 12 wherein said metal having a valence of +4 or +6 is at least one of titanium, molybdenum, and zirconium.

16. The method of claim 12 wherein said plasma coating is applied to a thickness of 100 nm to 3 μm.

17. The method of claim 12 further comprising applying an intermediate layer to said metal core by flame spraying prior to applying said plasma coating.

18. The method of claim 17 wherein said intermediate layer is a metallic intermediate layer comprising at least nickel, chromium, iron, boron, and silicon.

19. The method of claim 17 wherein said intermediate layer is a ceramic intermediate layer comprising at least one of chromic oxide and titanium dioxide.
